(19) United States
(12) Patent Application Publication
(10) Pub. No.: US 2017/0249558 A1
(43) Pub. Date: Aug. 31, 2017

(54) BLENDING CONNECTION RECOMMENDATION STREAMS

(71) Applicant: LinkedIn Corporation, Mountain View, CA (US)

(72) Inventors: Aastha Jain, Sunnyvale, CA (US); Shaunak Chatterjee, Sunnyvale, CA (US)

(21) Appl. No.: 15/210,455

(22) Filed: Jul. 14, 2016

Related U.S. Application Data
(60) Provisional application No. 62/301,452, filed on Feb. 29, 2016.

(51) Int. Cl. G06N 7/00; H04L 29/08; G06N 5/02

(52) U.S. Cl. CPC G06N 7/005; G06N 5/02; H04L 67/22

(57) ABSTRACT

A machine may be configured to blend connection recommendation streams. For example, the machine, based on a member identifier of a member of a SNS, accesses a list of other members of the SNS and a list of guests (e.g., non-members). The machine identifies a member probability value representing a likelihood of the member inviting another member to connect via the social graph of the member, and identifies a guest probability value representing a likelihood of the member inviting a guest to connect via the social graph. The machine generates a blended list of other members and guests based on the member probability values, the guest probability values, and a coefficient value selected to control a presence of a type of connections in the blended list. The machine generates recommendations for the member to invite people included in the blended list to connect with the member via the social graph.

### CLAIM OF PRIORITY

This patent application claims the benefit of priority, under 35 U.S.C. §119(e), to U.S. Provisional Patent Application No. 62/301,452 (Attorney Docket No. 2080.G10PRV) by Jain et al., filed on Feb. 29, 2016, which is hereby incorporated herein by reference in its entirety.

### TECHNICAL FIELD

The present application relates generally to the processing of data, and, in various example embodiments, to systems, methods, and computer program products for generating a connection recommendation stream that blends connection recommendations of members and non-members of a Social Networking Service.

### BACKGROUND

A company that is a Social Networking Service (SNS) (e.g., LinkedIn®) may make connection recommendations to its members to help the members to identify people with whom they might want to connect via the SNS. Generally, the recommended potential connections are other members of the SNS. Sometimes, the recommended potential connections are people who are not members of the SNS.

In some instances, the recommendation system of the SNS presents recommendations of members and recommendations of non-members to members in streams (e.g., lists) of connection recommendations displayed in user interfaces of devices of the members of the SNS. The connection recommendations may be presented in a particular fixed order (e.g., every third recommendation is of a non-member and follows two recommendations of members) in the streams of connection recommendations. Generally, the particular order of presenting the connection recommendations is the same for all the members of the SNS who receive connection recommendations without providing any customization of the recommendation presentation order.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a recommendation stream system, according to some example embodiments;

FIG. 3 is a flowchart illustrating a method for generating a blended connection recommendation stream, according to some example embodiments;

FIG. 4 is a flowchart illustrating a method for generating a blended connection recommendation stream, and representing additional steps of the method illustrated in FIG. 3, according to some example embodiments;

FIG. 5 is a flowchart illustrating a method for generating a blended connection recommendation stream, and representing additional steps of the method illustrated in FIG. 3, according to some example embodiments;

FIG. 6 is a flowchart illustrating a method for generating a blended connection recommendation stream, and representing additional steps of the method illustrated in FIG. 3, according to some example embodiments;

FIG. 7 is a flowchart illustrating a method for generating a blended connection recommendation stream, and representing step 308 of the method illustrated in FIG. 3 in more detail and an additional step of the method illustrated in FIG. 3, according to some example embodiments;

FIG. 8 is a flowchart illustrating a method for generating a blended connection recommendation stream, and representing steps 704 and 706 of the method illustrated in FIG. 7 in more detail, according to some example embodiments;

FIG. 9 is a block diagram illustrating a mobile device, according to some example embodiments; and

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems for generating a connection recommendation stream that blends connection recommendations of members and non-members of a Social Networking Service are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

A recommendation system of a Social Networking Service (SNS), such as LinkedIn®, may generate connection recommendations for its members to help the members to identify people with whom they might want to connect via the SNS and to invite the potential connections to join the SNS and become actual connections of the members via the SNS. The recommended potential connections may be other members of the SNS or people who are not members of the SNS (also referred to herein as “non-members of the SNS,” “non-members,” or “guests”).

The recommendation system of the SNS may present recommendations of members and recommendations of guests to a particular member in a stream (e.g., list) of connection recommendations. Often, the connection recommendations are displayed in a user interface of a device of the particular member in a particular fixed order (e.g., pattern). In some instances, the pattern that describes the combination of member recommendations and guest recommendation is selected based on a heuristic. According to an example heuristic, every third recommendation in the stream of connection recommendations is a connection recommendation of a non-member, and follows two connection recommendations of other members of the SNS. Traditionally, the selected recommendation presentation pattern (or order) is the same for all the members of the SNS who receive connection recommendations without consideration of data available for the particular members (e.g., member profile data, activity and behavior data, etc.) who receive the recommendations, and of data about the people being recommended for invitations to connect. Thus, although the recommendation results are personalized for each member, the traditional order of presenting the recommendation results is constant for all members based on the selected heuristic (e.g., every third connection recommendation is a guest recommendation that follows two connection recommendations that are member recommendations).

In some example embodiments, a recommendation stream system facilitates, for each member who receives connection recommendations, the generation of a connection recommendation stream that blends connection recommendations of other members of the SNS and of non-members of the SNS based on an analysis of member data pertaining to one or more members.

The recommendation stream system, in various example embodiments, based on a member identifier of a particular member (also referred to herein as a “recommendation viewing member,” or a “viewing member”) of SNS, accesses a first list of other members of the SNS and a second list of guests. The first list of members includes one or more other members who are potential connections of the particular member via a social graph of the particular member. The second list of guests includes one or more guests who are not members of the SNS and who are potential connections of the particular member via the social graph. The recommendation stream system, for each of the one or more other members, identifies a member probability (e.g., Pm) value that represents a likelihood of the particular member inviting another member of the one or more other members to connect via the social graph of the particular member. Each of the one or more other members is associated with their own Pm value. The recommendation stream system, for each of the one or more guests, also identifies a guest probability (e.g., Pg) value that represents a likelihood of the particular member inviting a guest of the one or more guests to connect via the social graph of the particular member.

The recommendation stream system generates a blended list of other members and guests for the particular member based on the member probability values associated with the one or more other members, the guest probability values associated with the one or more guests, and a coefficient value a selected to control a presence of a type of connections in the blended list. The recommendation stream system generates one or more connection recommendations for the particular member to invite one or more people included in the blended list to connect with the particular member via the social graph.

According to various example embodiments, the recommendation stream system multiplies the a value with one type of the P values (e.g., Pm or Pg) values to generate a weighted probability value of that type in order to enforce the presence of at least some connection recommendations for a type of invitee that the member is not as likely to invite. By using the coefficient value a, the recommendation stream system avoids presenting only member connection recommendation or only guest connection recommendations to the particular member. The a value gives a slight priority to one or the other type of invitee based on the type of growth planned for the SNS (e.g., members vs. guests). In some example embodiments, the a value is customized for a segment of members (e.g., a particular α value for all members from a particular country, market, membership segment, etc.).

In some example embodiments, the generating of the blended list of the other members and guests includes ranking the other members and guests based on the member probability values or guest probability values associated with them. Accordingly, other members or guests whose probabilities rank higher will appear higher in the blended list of other members and guests. For example, to determine whether a guest or another member should appear first in the blended list, the recommendation stream system compares αPg and Pm, where α is a coefficient selected based on a business rule (e.g., “show more guests if showing guests is important”). For example, if the value of Pg is much smaller than Pm, the Pg value may be multiplied by coefficient α selected to be greater than 1 to maintain a more blended connection recommendation stream (e.g., to avoid the guest recommendations appearing at the end of the connection recommendation stream).

According to certain example embodiments, the recommendation stream system generates a list of member recommendations. The recommendation stream system also generates a list of guest recommendations. The recommendation stream system may sort the list of member recommendations based on the Pm values in descending order. The recommendation stream system may also sort the list of guest recommendations based on the Pg values in descending order. The recommendation stream system uses the coefficient α to combine the sorted list of member recommendations and the sorted list of guest recommendations into a blended list of connection recommendations. For example, the coefficient α is equal to 2.0. Then the recommendation stream system may multiply Pg by 2.0, and may use a merge process to blend the two ordered lists of connection recommendations (e.g., the sorted list of member recommendations and the sorted list of guest recommendations) in descending order of their scores (e.g., Pm and Pg) into one blended list of connection recommendations. In some instances, other function of Pg and coefficient α may be used to modify the scores of the guest recommendations (e.g., Pg+coefficient α).

The value of the coefficient α may be chosen based on how much importance is given to a member-member connection vs. a member-guest connection. If this relative importance changes over time due to business constraints, the value of coefficient α may also change.

Consistent with some example embodiments, the recommendation stream system generates one or more connection recommendations for the particular member to invite one or more people included in the blended list to connect with the particular member via the social graph. The recommendation stream system may display one or more connection recommendations generated for the particular member in a blended stream of connection recommendations in a user interface of a device associated with the particular member. The blended stream of connection recommendations may be a list of connection recommendations that includes both member connection recommendations and guest connection recommendations that have been ordered within the blended stream based on probability values that are associated with various invitees and that represent various likelihoods of the particular member inviting the various invitees to connect with the particular member via the SNS. Accordingly, the other members or guests ranked higher based on the likelihood of the particular member (e.g., the member who receives the connection recommendations) of sending invitations to them appear first in the blended stream of connection recommendations.

In some example embodiments, if the particular member is more likely to send member invitations than guest invitations, then their Pm values are higher than Pg values, and, as a result, the recommendation stream system presents more member recommendations than guest recommendations. Also, more member recommendations are presented at the beginning of the blended stream of connection recommendations.

In order to generate a more balanced blended list, the recommendation stream system, for each of the one or more guests, generates a weighted guest probability value based on multiplying the coefficient value and the guest probability value, and orders identifiers of the one or more other members and identifiers of the one or more guests in the blended list based on a ranking of the member probability values and the weighted guest probability values. The recommendation stream system then may cause a presentation of the one or more connection recommendations in a user interface of a device associated with the particular member based on the ordered identifiers in the blended list.

In other example embodiments, if the particular member is more likely to send guest invitations than member invitations, then their Pg values are higher than Pm values, and, as a result, the recommendation stream system presents more guest recommendations than member recommendations in the blended stream of connection recommendations. Also, more guest recommendations are presented at the beginning of the blended stream of connection recommendations.

In order to generate a more balanced blended list, the recommendation stream system, for each of the one or more other members, generates a weighted member probability value based on multiplying the coefficient value and the member probability value, and orders identifiers of the one or more other members and identifiers of the one or more guests in the blended list based on a ranking of the weighted member probability values and the guest probability values. The recommendation stream system then may cause a presentation of the one or more connection recommendations in a user interface of a device associated with the particular member based on the ordered identifiers in the blended list.

According to some example embodiments, the member probability value Pm that the particular member would invite another member is determined by the recommendation stream system as a function of a set of member profile features and/or social graph features of the particular member, and past behaviors and activities by the particular member.

According to some example embodiments, the guest probability value Pg that the particular member would invite a guest is determined by the recommendation stream system as a function of a set of past behaviors and activities by the particular member.

In some example embodiments, if a viewing member has never invited a guest and only has invited members to connect, then that reflects itself in the Pg and Pm values: Pg will be low for the potential guest invitees and Pm will be high for the potential member invitees. When ordering the list of potential invitees based on the Pg or Pm values of the invitees, the other members will appear at the top of the list and the guests will appear at the bottom of the list. Because, in some instances, the value of Pg is much smaller than Pm, the Pg value may be multiplied by the coefficient α selected to be greater than 1 to maintain a more blended connection recommendation stream (e.g., to avoid the guest recommendations appearing at the end of the connection recommendation stream). In certain example embodiments, a single coefficient α is used for all users. In various example embodiments, different values for coefficient α are used for different user segments. In certain example embodiments, based on the growth objectives, the coefficient α takes a value between 0.00 and 1.00. In certain example embodiments, based on the growth objectives, the coefficient α is greater than 1.00.

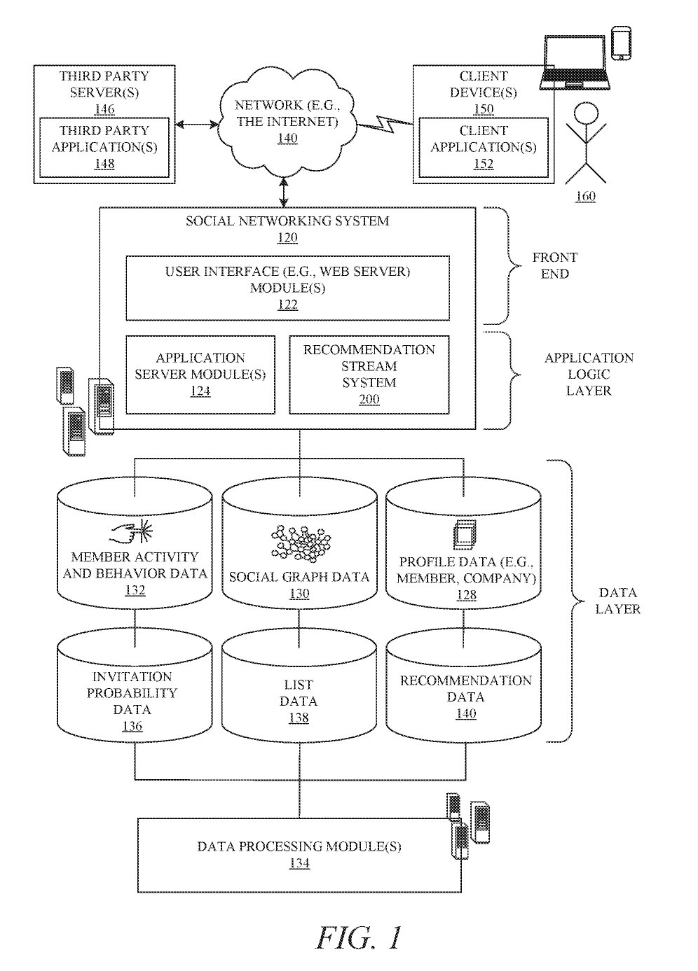

An example method and system for generating a blended connection recommendation stream may be implemented in the context of the client-server system illustrated in FIG. 1. As illustrated in FIG. 1, the recommendation stream system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

In some example embodiments, members may receive connection recommendations that identify other people (e.g., members of the social networking service or non-members) who are potential connections for the members. The connection recommendations may be stored in and accessed at database 140. The recommendation stream system 200 may present, to a particular member, a mix of connection recommendations of members and connection recommendations of non-members in a blended connection recommendation stream. The connection recommendation stream may be a list of connection recommendations of members and of non-members that is blended (e.g., mixed) for the particular member based on member data pertaining to particular member. The particular blended connection recommendation streams generated for particular members may be stored in and accessed at database 138.

In various example embodiments, the recommendation stream system 200 orders connection recommendations in a particular blended connection recommendation stream for a particular member based on the likelihood of the particular member inviting another person (e.g., a particular other member or a particular guest) to connect with the particular member via the SNS. An invitation probability value is associated with a particular invitee: a member invitee or a guest invitee. The invitation probability value for a member invitee may be generated by a probability determining model based on a set of member profile features and/or member activity and behavior data pertaining to one or more members (e.g., the inviting member, the member invitee, etc.). The invitation probability value for a guest may be generated by a further probability determining model based on a set of member profile features and/or member activity and behavior data pertaining to the inviting member and data available with respect to the guest. The various probability values (e.g., member probability values and guest probability values) may be stored in and accessed at (e.g., identified in) database 136.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124.

Other applications and services may be separately embodied in their own application server modules 124. As illustrated in FIG. 1, social networking system 120 may include the recommendation stream system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, invitation probability data, blended list data, or recommendation data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers of a large-scale distributed storage and processing framework, such as Hadoop servers, for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

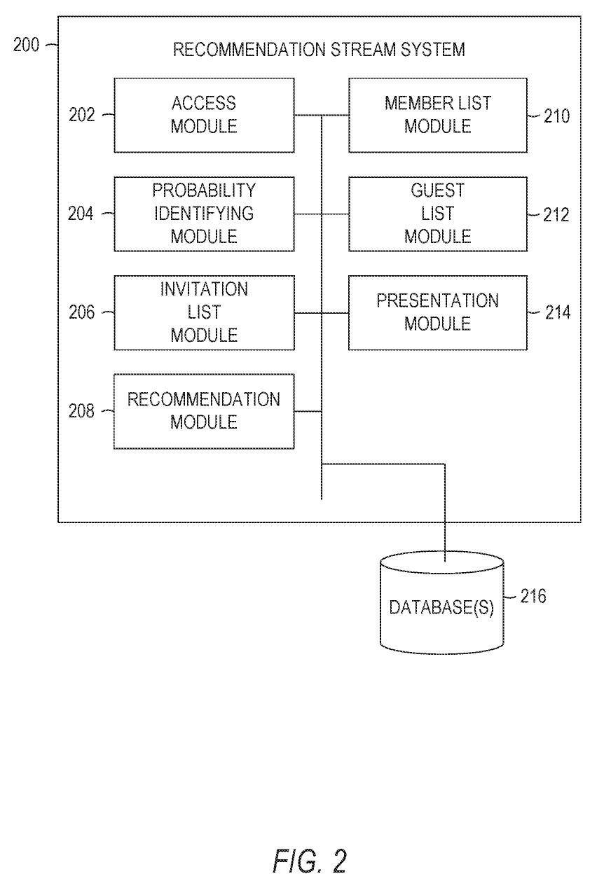

FIG. 2 is a block diagram illustrating components of the recommendation stream system 200, according to some example embodiments. As shown in FIG. 2, the recommendation stream system 200 includes an access module 202, a probability identifying module 204, an invitation list module 206, a recommendation module 208, a member list module 210, a guest list module 212, and a presentation module 214, all configured to communicate with each other (e.g., via a bus, shared memory, or a switch).

According to some example embodiments, the access module 202, based on a member identifier of a particular member of a Social Networking Service (SNS), accesses a list (e.g., a first list) of other members of the SNS. The first list of members includes one or more other members who are potential connections of the particular member via a social graph of the particular member.

The access module also accesses another list (e.g., a second list) of guests. The second list of guests includes one or more guests who are not members of the SNS and who are potential connections of the particular member via the social graph of the particular member.

The probability identifying module 204, for each of the one or more other members, identifies a member probability value that represents a likelihood of the particular member inviting another member of the one or more other members to connect via the social graph of the particular member. In some instances, the member probability value is a function of a set of member profile features. Additionally or alternately, the member probability value is a function of a set of member activity features.

The probability identifying module 204, for each of the one or more guests, identifies a guest probability value that represents a likelihood of the particular member inviting a guest of the one or more guests to connect via the social graph of the particular member. In some instances, the guest probability value is a function of a set of member activity features.

The invitation list module 206 generates a blended list of other members and guests for the particular member based on the member probability values associated with the one or more other members, the guest probability values associated with the one or more guests, and a coefficient value selected to control a presence of a type of connections in the blended list. In various example embodiments, the coefficient is selected for a particular segment of the members of the SNS based on a member profile feature common to the segment or activity feature common to the segment, and is used only for the particular segment but not for other segments of the members of the SNS. In some instances, a different coefficient value is selected for one or more other segments of the members of the SNS.

In some example embodiments, the generating of the blended list of other members and guests includes, for each of the one or more guests, generating a weighted guest probability value based on multiplying the coefficient value and the guest probability value, and ordering identifiers of the one or more other members and identifiers of the one or more guests in the blended list based on a ranking of the member probability values and the weighted guest probability values.

The recommendation module 208 generates one or more connection recommendations for the particular member to invite one or more people included in the blended list to connect with the particular member via the social graph of the particular member.

The member list module 210 selects the one or more members from a further (e.g., a second) social graph of an actual connection of the particular member on the SNS. The selecting may be based on identifying the one or more members in the second social graph who have a member profile feature in common with the particular member. Examples of member profile features in common are attending the same educational institution over overlapping period of time, working at the same company over overlapping period of time, being members of one or more groups on the SNS, etc. The member list module 210 also generates the first list of other members of the SNS based on the selected one or more other members.

The guest list module 212, in some example embodiments, accesses data pertaining to past behavior and activity associated with the particular member. The guest list module 212 generates the second list of guests based on the data pertaining to the past behavior and activity associated with the particular member.

The guest list module 212, in certain example embodiments, determines that the particular member sent an email message to one or more contacts (e.g., people that the particular member may know). The determining may be based on an analysis of the member activity and behavior data associated with the particular member. The member activity and behavior data associated with the particular member may be stored and accessed at database 216 (e.g., member activity and behavior database 132). The guest list module 212 determines that the one or more contacts are not members of the SNS. The determining that the selected one or more contacts are not members of the SNS may be based on comparing an email address of a contact of the particular member with email addresses of the members of the SNS. The guest list module 212 generates the second list of guests based on the determining that the particular member sent an email message to the one or more contacts, and the determining that the one or more contacts are not members of the SNS.

The presentation module 214 causes a presentation of the one or more connection recommendations in a user interface of a device associated with the particular member based on the blended list.

In various example embodiments, the ordering of the identifiers of the one or more other members and identifiers of the one or more guests in the blended list includes comparing the member probability value associated with the other member and the weighted guest probability value, and ranking the member probability value and the weighted guest probability value in a decreasing order based on the comparing of the member probability value and the weighted guest probability value. The causing of the presentation of the one or more connection recommendations includes causing a presentation of a first connection recommendation for the other member and a second recommendation for the guest based on the ranking of the member probability value and the weighted guest probability value in the decreasing order.

To perform one or more of its functionalities, the recommendation stream system 200 may communicate with one or more other systems. For example, an integration engine may integrate the recommendation stream system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 216 (e.g., database 128, 130, 132, 136, 138, or 140).

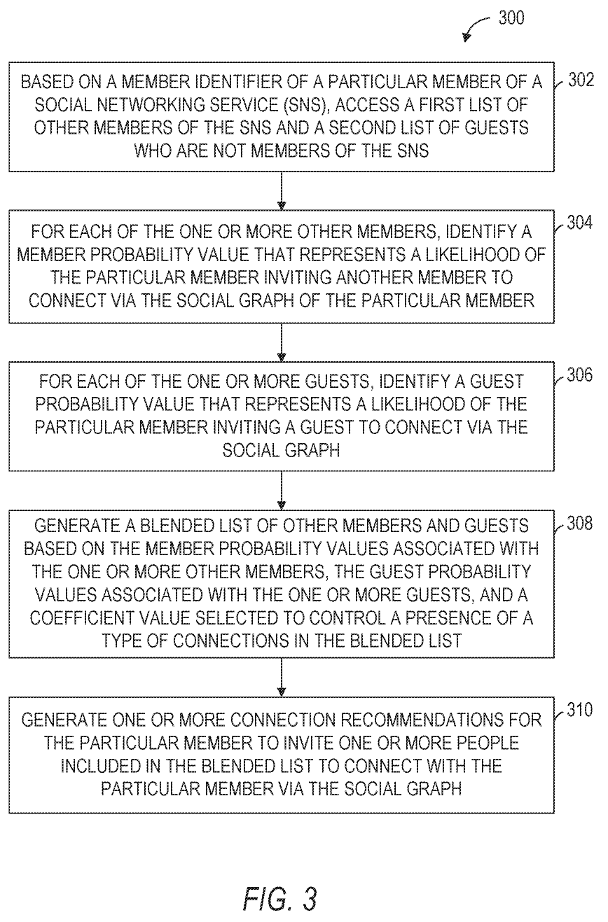

FIGS. 3-8 are flowcharts illustrating a method for generating recruitment leads based on targeted content, according to some example embodiments. The operations of method 300 illustrated in FIG. 3 may be performed using modules described above with respect to FIG. 2. As shown in FIG. 3, method 300 may include one or more of method operations 302, 304, 306, 308, and 310, according to some example embodiments.

At operation 302, the access module 202, based on a member identifier of a particular member of a Social Networking Service (SNS), accesses a first list of other members of the SNS and a second list of guests at a database (e.g., the list database 138). The first list of members includes one or more other members who are potential connections of the particular member via a social graph of the particular member. The second list of guests includes one or more guests who are not members of the SNS and who are potential connections of the particular member via the social graph.

At operation 304, the probability identifying module 204, for each of the one or more other members, identifies (e.g., accesses in the invitation probability database 136) a member probability value. The member probability value represents a likelihood of the particular member inviting another member of the one or more other members to connect via the social graph of the particular member.

At operation 306, the probability identifying module 204, for each of the one or more guests, identifies (e.g., accesses in the invitation probability database 136) a guest probability value. The guest probability data represents a likelihood of the particular member inviting a guest of the one or more guests to connect via the social graph of the particular member.

At operation 308, the invitation list module 306 generates a blended list of other members and guests for the particular member. The generating of the blended list (e.g., of the order of the guests and other members in the blended list) may be based on the member probability values associated with the one or more other members, the guest probability values associated with the one or more guests, and a coefficient value selected to control a presence of a type of connections in the blended list.

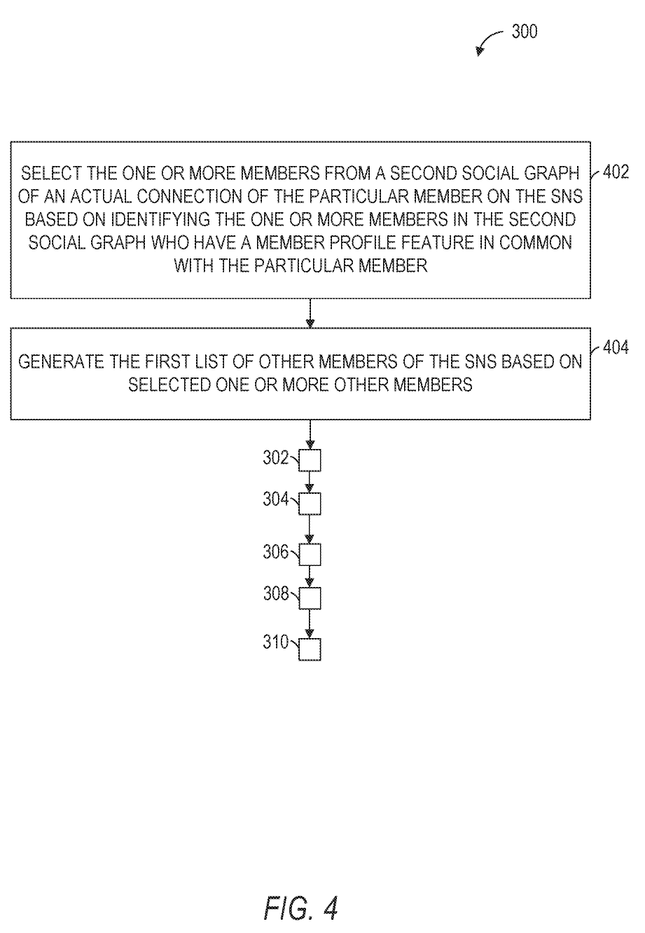

At operation 310, the recommendation module 208 generates one or more connection recommendations for the particular member to invite one or more people included in the blended list to connect with the particular member via the social graph. Further details with respect to the operations of the method 600 are described below with respect to FIGS. 4-9.

As shown in FIG. 4, method 300 may include one or more of operations 402 and 404, according to some example embodiments. Operation 402 may be performed before operation 302, in which the access module 202, based on a member identifier of a particular member of the SNS, accesses a first list of other members of the SNS and a second list of guests. The social graph of the particular member may be a first social graph of the particular member. Other members of the SNS may be associated with other social graphs that represent the member connections of the other members via the SNS. For example, the particular member is connected to ten other members via the first social graph associated with the particular member. Each of these ten members are actual connections of the particular member via the SNS. Also, each of these ten members, is associated with a particular social graph that represents the actual connections via the SNS of the respective member. Furthermore, each of these ten members have the particular member as an actual connection in their social graphs.

At operation 402, the member list module 210 selects the one or more members from a second social graph of an actual connection of the particular member on the SNS. The selecting of the one or more members may be based on identifying the one or more members in the second social graph who have a member profile feature in common with the particular member. For example, the member list module 210 selects a further member from the second social graph of an actual connection of the particular member based on determining that the particular member and the further member went to the same university during the same time.

Operation 404 may be performed after operation 402 and before operation 306. At operation 404, the member list module 210 generates the first list of other members of the SNS based on the selected one or more other members.

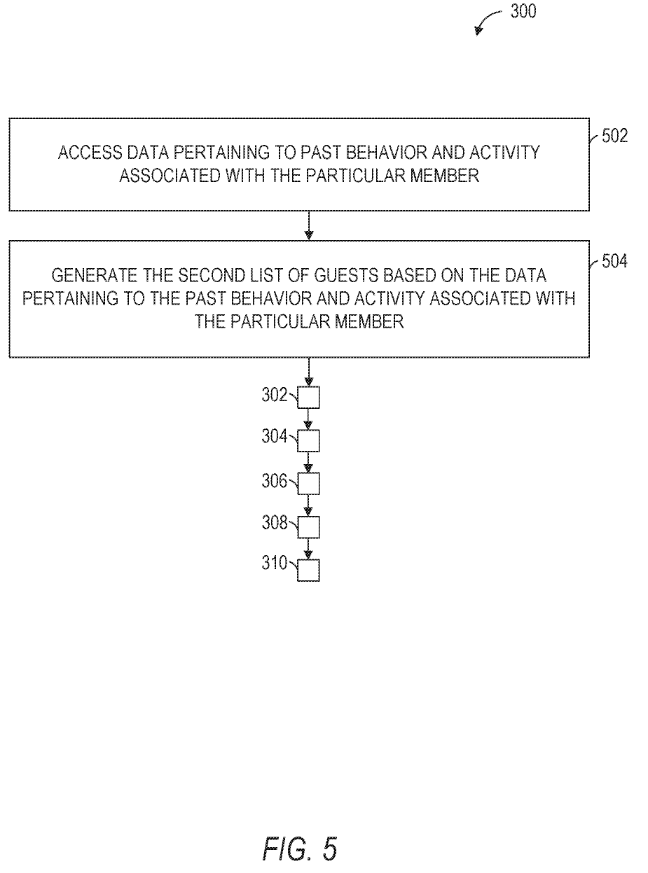

As shown in FIG. 5, method 300 may include one or more of operations 502 and 504, according to some example embodiments. Operation 502 may be performed before operation 302, in which the access module 202, based on a member identifier of a particular member of the SNS, accesses a first list of other members of the SNS and a second list of guests.

At operation 502, the guest list module 212 accesses data pertaining to past behavior and activity associated with the particular member from a database 216 (e.g., member activity and behavior database 132).

Operation 504 may be performed after operation 502. At operation 508, the guest list module 212 generates the second list of guests based on the data pertaining to the past behavior and activity associated with the particular member. In some example embodiments, the generating of the second list includes identifying potential guests who may be included in the second list of guests based on an analysis of the data pertaining to the past behavior and activity associated with the particular member, and selecting one or more potential guests to be included in the second list of guests based on determining that the one or more potential guests are not members of the SNS.

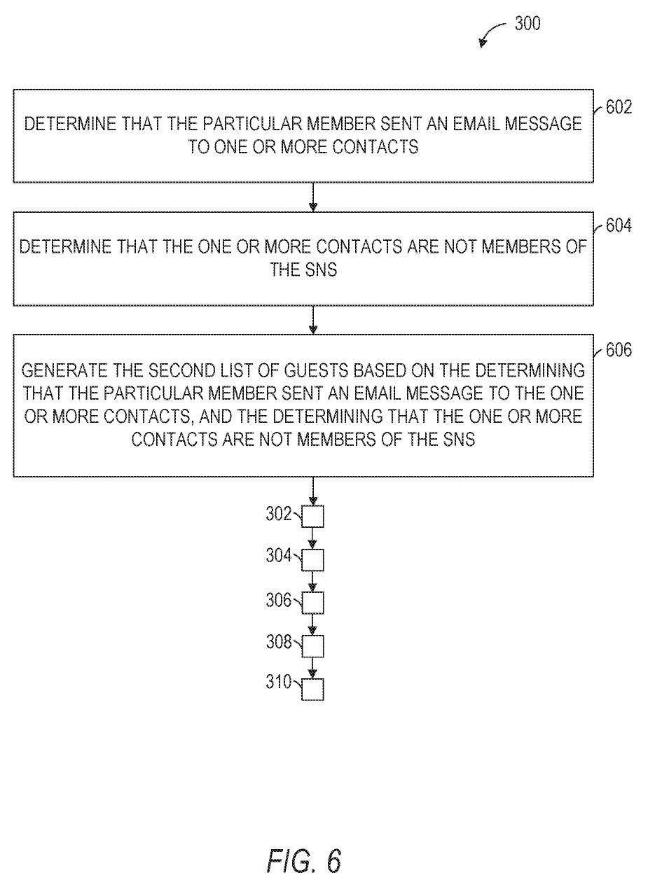

As shown in FIG. 6, method 300 may include one or more of operations 602, 604, and 606, according to some example embodiments. Operation 602 may be performed before operation 302, in which the access module 202, based on a member identifier of a particular member of the SNS, accesses a first list of other members of the SNS and a second list of guests.

At operation 602, the guest list module 212 determines that the particular member sent an email message to one or more contacts. The determining may be based on an analysis of the member activity and behavior data associated with the particular member. The member activity and behavior data associated with the particular member may be stored and accessed at database 216 (e.g., member activity and behavior database 132).

Operation 604 may be performed after operation 602. At operation 604, the guest list module 212 determines that the one or more contacts are not members of the SNS. The determining that the one or more contacts are not members of the SNS may be based on a comparison of the email address of the guest and the email addresses of the members of the SNS.

Operation 606 may be performed after operation 604. At operation 606, the guest list module 212 generates the second list of guests based on the determining that the particular member sent an email message to the one or more contacts, and the determining that the one or more contacts are not members of the SNS.

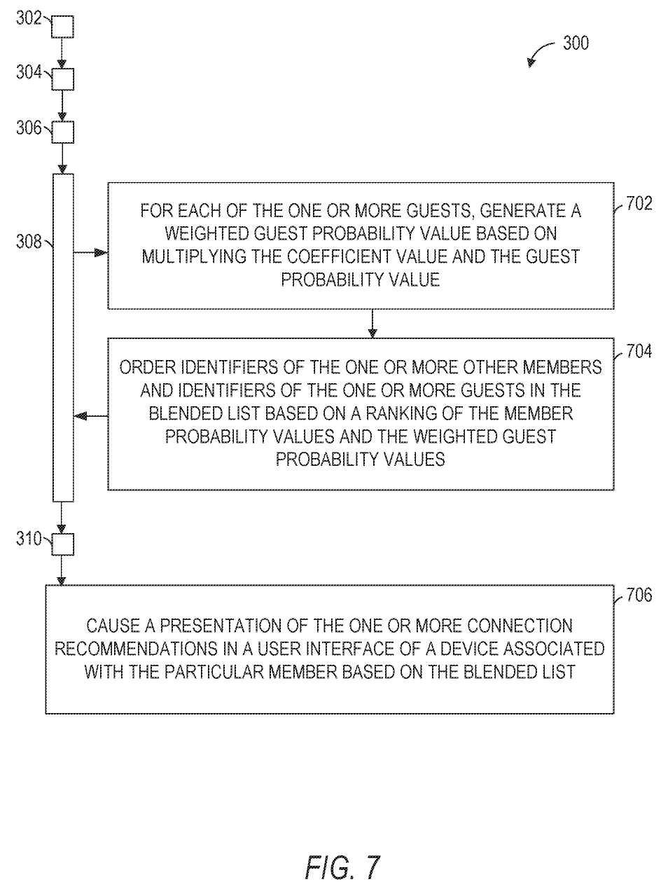

As shown in FIG. 7, method 300 may include one or more of operations 702, 704, and 706, according to some example embodiments. Operation 702 may be performed as part (e.g., a precursor task, a subroutine, or a portion) of operation 308, in which the invitation list module 306 generates a blended list of other members and guests for the particular member.

At operation 702, the invitation list module 306, for each of the one or more guests, generates a weighted guest probability value based on multiplying the coefficient value and the guest probability value.

Operation 704 may be performed as part of operation 308 after operation 702. At operation 704, the invitation list module 306 orders identifiers of the one or more other members and identifiers of the one or more guests in the blended list. The ordering may be based on a ranking of the member probability values and the weighted guest probability values. The ranking of the various probability values may be in decreasing order.

Operation 706 may be performed after operation 310, in which the recommendation module 208 generates one or more connection recommendations for the particular member to invite one or more people included in the blended list to connect with the particular member via the social graph. At operation 706, the presentation module 214 causes a presentation of the one or more connection recommendations in a user interface of a device associated with the particular member based on the blended list (e.g., based on the order of identifiers of guests and other members in the blended list).

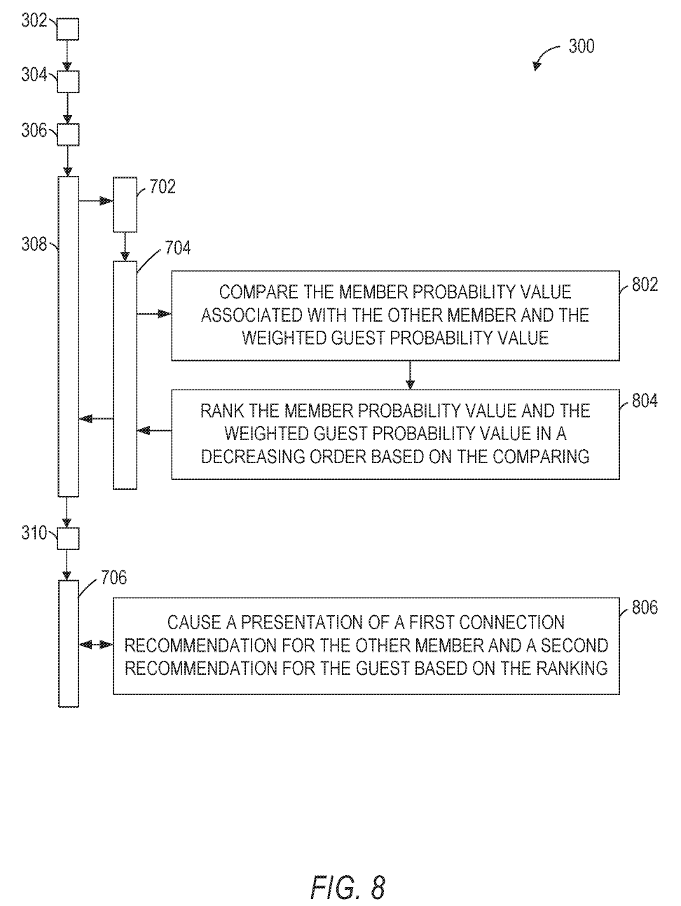

As shown in FIG. 8, method 300 may include one or more of operations 802, 804, and 806, according to some example embodiments. Operation 802 may be performed as part of operation 704 of method 300 illustrated in FIG. 7, in which the invitation list module 306 orders identifiers of the one or more other members and identifiers of the one or more guests in the blended list. At operation 802, the invitation list module 306 compares the member probability value associated with the other member and the weighted guest probability value.

Operation 804 may be performed as part of operation 704 after operation 802. At operation 804, the invitation list module 306 ranks the member probability value and the weighted guest probability value in a decreasing order based on the comparing of the member probability value and the weighted guest probability value.

Operation 806 may be performed as part of operation 706 of method 300 illustrated in FIG. 7, in which the presentation module 214 causes a presentation of the one or more connection recommendations in a user interface of a device associated with the particular member based on the blended list. At operation 806, the presentation module 214 causes a presentation of a first connection recommendation for the other member and a second recommendation for the guest based on the ranking of the member probability value and the weighted guest probability value.

### Example Mobile Device

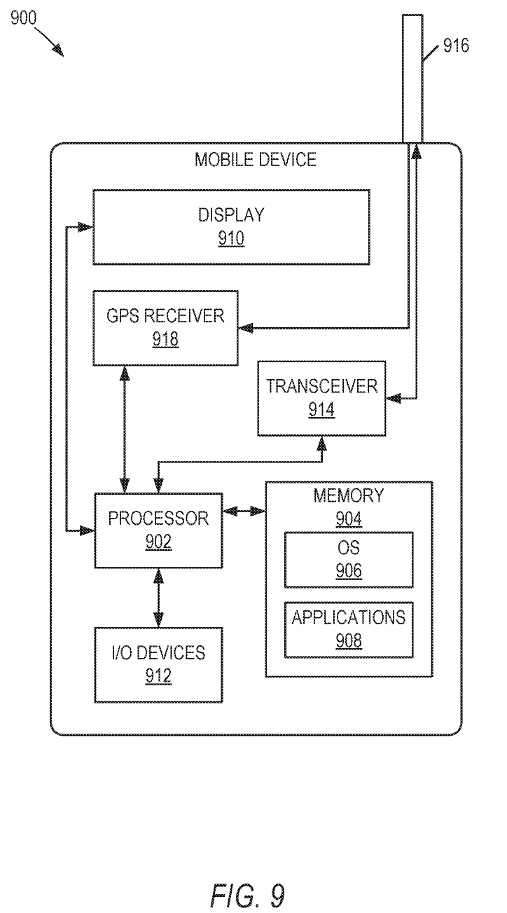

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

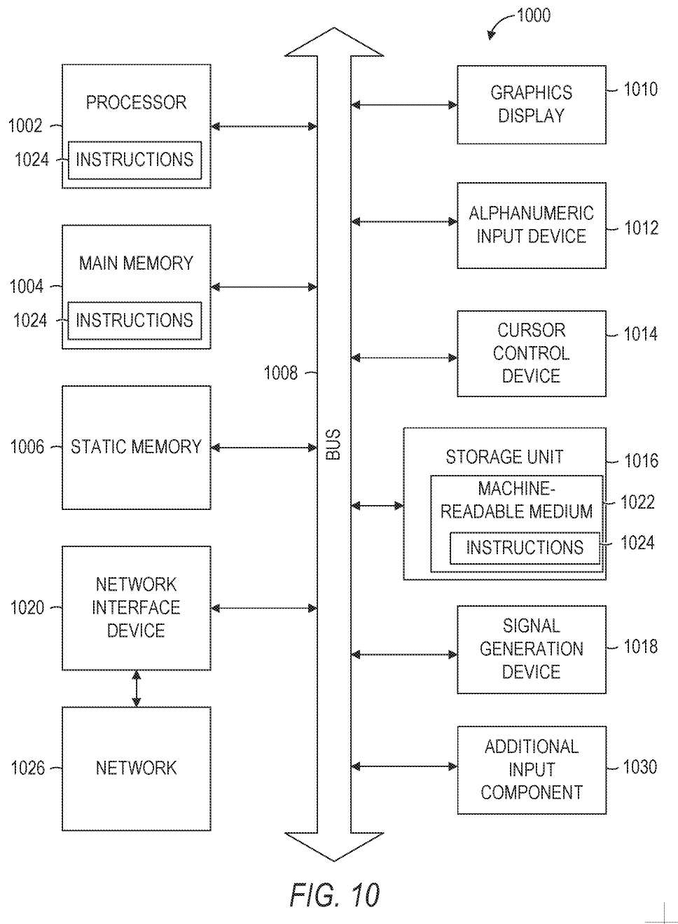

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 1026 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
based on a member identifier of a particular member of a Social Networking Service (SNS), accessing a first list of other members of the SNS and a second list of guests, the first list of members including one or more other members who are potential connections of the particular member via a social graph of the particular member, the second list of guests including one or more guests who are not members of the SNS and who are potential connections of the particular member via the social graph;
for each of the one or more other members, identifying a member probability value that represents a likelihood of the particular member inviting another member of the one or more other members to connect via the social graph of the particular member;
for each of the one or more guests, identifying a guest probability value that represents a likelihood of the particular member inviting a guest of the one or more guests to connect via the social graph of the particular member;
generating, using one or more hardware processors, a blended list of other members and guests for the particular member based on the member probability values associated with the one or more other members, the guest probability values associated with the one or more guests, and a coefficient value selected to control a presence of a type of connections in the blended list; and
generating one or more connection recommendations for the particular member to invite one or more people included in the blended list to connect with the particular member via the social graph.

2. The method of claim 1, wherein the social graph is a first social graph of the particular member, the method further comprising:
selecting the one or more members from a second social graph of an actual connection of the particular member on the SNS based on identifying the one or more members in the second social graph who have a member profile feature in common with the particular member; and
generating the first list of other members of the SNS based on selected one or more other members.

3. The method of claim 1, further comprising:
accessing data pertaining to past behavior and activity associated with the particular member; and
generating the second list of guests based on the data pertaining to the past behavior and activity associated with the particular member.

4. The method of claim 1, further comprising:
determining that the particular member sent an email message to one or more contacts;
determining that the one or more contacts are not members of the SNS; and
generating the second list of guests based on the determining that the particular member sent an email message to the one or more contacts, and the determining that the one or more contacts are not members of the SNS.

5. The method of claim 1, wherein the generating of the blended list includes:
for each of the one or more guests, generating a weighted guest probability value based on multiplying the coefficient value and the guest probability value, and
ordering identifiers of the one or more other members and identifiers of the one or more guests in the blended list based on a ranking of the member probability values and the weighted guest probability values,
the method further comprising:
causing a presentation of the one or more connection recommendations in a user interface of a device associated with the particular member based on the blended list.

6. The method of claim 5, wherein the ordering includes:
comparing the member probability value associated with the other member and the weighted guest probability value, and
ranking the member probability value and the weighted guest probability value in a decreasing order based on the comparing of the member probability value and the weighted guest probability value,
wherein the causing of the presentation of the one or more connection recommendations includes causing a presentation of a first connection recommendation for the other member and a second recommendation for the guest based on the ranking of the member probability value and the weighted guest probability value.

7. The method of claim 1, wherein the member probability value is a function of a set of member profile features.

8. The method of claim 1, wherein the member probability value is a function of a set of member activity features.

9. The method of claim 1, wherein the coefficient is selected for a segment of the members of the SNS based on a member profile feature common to the segment.

10. A system comprising:
one or more hardware processors; and
a machine-readable medium for storing instructions that, when executed by the one or more hardware processors, cause the one or more hardware processors to perform operations comprising:
based on a member identifier of a particular member of a Social Networking Service (SNS), accessing a first list of other members of the SNS and a second list of guests, the first list of members including one or more other members who are potential connections of the particular member via a social graph of the particular member, the second list of guests including one or more guests who are not members of the SNS and who are potential connections of the particular member via the social graph;
for each of the one or more other members, identifying a member probability value that represents a likelihood of the particular member inviting another member of the one or more other members to connect via the social graph of the particular member;
for each of the one or more guests, identifying a guest probability value that represents a likelihood of the particular member inviting a guest of the one or more guests to connect via the social graph of the particular member;
generating a blended list of other members and guests for the particular member based on the member probability values associated with the one or more other members, the guest probability values associated with the one or more guests, and a coefficient value selected to control a presence of a type of connections in the blended list; and
generating one or more connection recommendations for the particular member to invite one or more people included in the blended list to connect with the particular member via the social graph.

11. The system of claim 10, wherein the social graph is a first social graph of the particular member, and wherein the operations further comprise:
selecting the one or more members from a second social graph of an actual connection of the particular member on the SNS based on identifying the one or more members in the second social graph who have a member profile feature in common with the particular member; and
generating the first list of other members of the SNS based on selected one or more other members.

12. The system of claim 10, wherein the operations further comprise:
accessing data pertaining to past behavior and activity associated with the particular member; and
generating the second list of guests based on the data pertaining to the past behavior and activity associated with the particular member.

13. The system of claim 10, wherein the operations further comprise:
determining that the particular member sent an email message to one or more contacts;
determining that the one or more contacts are not members of the SNS; and
generating the second list of guests based on the determining that the particular member sent an email message to the one or more contacts, and the determining that the one or more contacts are not members of the SNS.

14. The system of claim 10, wherein the generating of the blended list includes:
for each of the one or more guests, generating a weighted guest probability value based on multiplying the coefficient value and the guest probability value; and
ordering identifiers of the one or more other members and identifiers of the one or more guests in the blended list based on a ranking of the member probability values and the weighted guest probability values, and
wherein the operations further comprise:
causing a presentation of the one or more connection recommendations in a user interface of a device associated with the particular member based on the blended list.

15. The system of claim 14, wherein the ordering includes:
comparing the member probability value associated with the other member and the weighted guest probability value, and
ranking the member probability value and the weighted guest probability value in a decreasing order based on the comparing of the member probability value and the weighted guest probability value,
wherein the causing of the presentation of the one or more connection recommendations includes causing a presentation of a first connection recommendation for the other member and a second recommendation for the guest based on the ranking of the member probability value and the weighted guest probability value.

16. The system of claim 10, wherein the member probability value is a function of a set of member profile features.

17. The system of claim 10, wherein the member probability value is a function of a set of member activity features.

18. The system of claim 10, wherein the coefficient is selected for a segment of the members of the SNS based on a member profile feature common to the segment.

19. A non-transitory machine-readable medium comprising instructions that, when executed by one or more hardware processors, cause the one or more hardware processors to perform operations comprising:
based on a member identifier of a particular member of a Social Networking Service (SNS), accessing a first list of other members of the SNS and a second list of guests, the first list of members including one or more other members who are potential connections of the particular member via a social graph of the particular member, the second list of guests including one or more guests who are not members of the SNS and who are potential connections of the particular member via the social graph;
for each of the one or more other members, identifying a member probability value that represents a likelihood of the particular member inviting another member of the one or more other members to connect via the social graph of the particular member;
for each of the one or more guests, identifying a guest probability value that represents a likelihood of the particular member inviting a guest of the one or more guests to connect via the social graph of the particular member;
generating a blended list of other members and guests for the particular member based on the member probability values associated with the one or more other members, the guest probability values associated with the one or more guests, and a coefficient value selected to control a presence of a type of connections in the blended list; and
generating one or more connection recommendations for the particular member to invite one or more people included in the blended list to connect with the particular member via the social graph.

20. The non-transitory machine-readable medium of claim 19, wherein the generating of the blended list includes:
for each of the one or more guests, generating a weighted guest probability value based on multiplying the coefficient value and the guest probability value; and
ordering identifiers of the one or more other members and identifiers of the one or more guests in the blended list based on a ranking of the member probability values and the weighted guest probability values, and
wherein the operations further comprise:
causing a presentation of the one or more connection recommendations in a user interface of a device associated with the particular member based on the blended list.
